(19) United States
(12) Patent Application Publication
(10) Pub. No.: US 2025/0352961 A1
(43) Pub. Date: Nov. 20, 2025

(54) Reducing Corrosion and Fouling Inside Pipelines

(71) Applicant: Saudi Arabian Oil Company, Dhahran (SA)

(72) Inventor: Khaled Abdullah AL-Buraik, Dhahran (SA)

(21) Appl. No.: 18/668,861

(22) Filed: May 20, 2024

(51) Int. Cl. B01F 27/96; B01F 23/41; B01F 23/43; B01F 27/13; B01F 35/32; C02F 5/08

(52) U.S. Cl. CPC B01F 27/96; B01F 23/41; B01F 23/431; B01F 27/13; B01F 35/32015; C02F 5/08

(57) ABSTRACT

Methods for reducing corrosion or fouling in a pipeline can include identifying a location in the pipeline where inhomogeneities in the fluid produce the conditions that promote corrosion or fouling. A mixing unit can be installed based on the identified location with blades of the mixing unit positioned inside the pipeline. Homogeneity of fluid in the pipeline can be increased downstream of the mixing unit by flowing the combined first fluid and second fluid past the blades of the mixing unit.

### TECHNICAL FIELD

This specification relates to reducing corrosion and fouling inside pipelines, particularly using dynamic flow disruptors.

### BACKGROUND

Fouling (e.g., scale deposits and microorganisms (biofouling)) and corrosion inside pipelines including is a major challenge in the oil and gas industry. During hydrocarbon transportation from wellheads to the processing facilities, scaling and biofoulants (e.g., calcium-sulfate (CaSO₄) or calcium carbonate (CaCO₃)) can accumulate inside pipelines carrying the hydrocarbons and reduce the volume capacity of the pipelines. These buildups can increase pressure and temperature inside pipelines, reduce the flow of the fluids through the pipelines, and, in some cases, cause catastrophic damage to the integrity of the pipelines.

### SUMMARY

This specification describes an approach to reducing corrosion and fouling inside pipelines using dynamic flow disruptors (e.g., flow-driven mixing turbines). In one application of this approach, a mixing unit installed in a pipeline interrupts development of scale and biofouling by homogenizing the fluid in a pipeline where flow conditions (e.g., low velocities) have led to the separation of oil and water produced from a subsurface formation. This separation can be particularly problematic in situations where saline rich produced is stagnant or flow at very low velocities. In another application of this approach, a mixing unit installed in a pipeline interrupts development of scale and biofouling by homogenizing the flow and temperature of merged flow streams.

This mixing unit can include blades (e.g., helical blades) whose rotation is driven by fluid flow through the mixing unit. By providing vigorous mixing inside the pipeline, this approach reduces the likelihood that stagnation induced oil-water separation or compounds associated with scaling and biofouling have enough time to saturate and precipitate after the mixer unifies the flow and pushes the stream for further processing. This effect reduces the chance of corrosion and fouling scale accumulation in the pipeline.

Some systems include a generator driven by a shaft of the blades of the mixing unit.

The systems and methods described in this specification can provide one or more of the following advantages.

By actively mixing separated fluids, this approach can prevent/mitigate corrosion caused by the separation of water from oil. In stagnant or low velocity flow conditions, water can accumulate at the bottom of a pipeline and cause or accelerate corrosion at the bottom section of the pipe (i.e., the 6 o'clock position). This can be particularly significant for high-salinity produced fluids.

By actively mixing merged flow streams, this approach can reduce corrosion and fouling in inside pipelines while reducing or avoiding the costs associated with chemical treatment. Additionally, these systems and methods can generate electricity which can be returned to a facility electrical grid or used locally (e.g., to power chemical dosing pumps installed near the mixing unit).

This approach is anticipated to be more efficient than membrane and magnetic water treatment methods as well as being more applicable to the types of streams present in oil and gas pipelines. This approach is also anticipated to be simpler to execute than chemical treatment-based approaches which require constant adjustment and chemical procurement. It also reduces or avoids the negative impacts of chemical treatment approaches on the quality of the stream.

Fouling can reduce the production volume capacity of a pipeline as well as increasing pressure and temperature inside the pipeline; reducing the quality of the stream, and causing catastrophic damage to the integrity of the pipeline. In pipelines with major fouling; leakages, corrosion, bowing, and ballooning are very common mode of pipeline failures. By reducing fouling and corrosion, this approach can reduce the likelihood of pipeline failures and reduce the major safety and health risks to personnel and negative environmental impacts of pipeline failures.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 illustrates a system for reducing corrosion and fouling inside pipelines.

FIGS. 2A-2C are schematic side views illustrating an application of the system.

FIG. 3 is a schematic top view of illustrating an application of the system.

FIG. 4 is a flowchart of a method of reducing corrosion and fouling inside pipelines.

Like reference symbols in the various drawings indicate like elements.

### DETAILED DESCRIPTION

This specification describes an approach to reducing corrosion and fouling inside pipelines using dynamic flow disruptors (e.g., flow-driven mixing turbines). In one application of this approach, a mixing unit installed in a pipeline interrupts development of scale and biofouling by homogenizing the fluid in a pipeline where flow conditions (e.g., low velocities) have led to the separation of oil and water produced from a subsurface formation. This separation can be particularly problematic in situations where saline rich produced is stagnant or flow at very low velocities. In another application of this approach, a mixing unit installed in a pipeline interrupts development of scale and biofouling by homogenizing the flow and temperature of merged flow streams.

This mixer unit can include with helical blades whose rotation is driven by fluid flow through the mixing unit. By providing vigorous mixing inside the pipeline, this approach reduces the likelihood that compounds associated with scaling and biofouling have enough time to saturate and precipitate after the mixer unifies the flow and pushes the stream for further processing. This effect reduces the chance of corrosion and fouling scale accumulation in the pipeline. Some systems include a generator driven by a shaft of the supporting blades of the mixing unit.

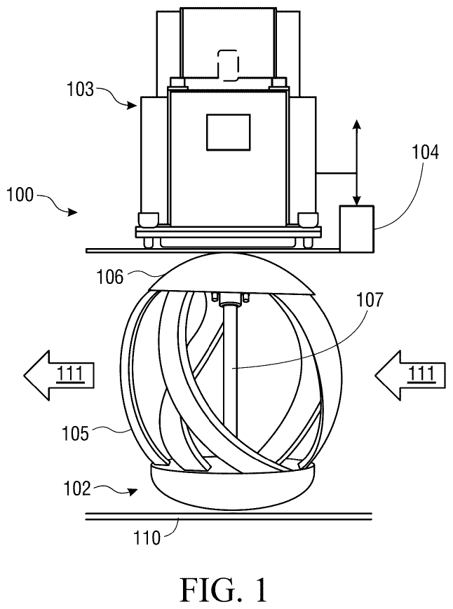

FIG. 1 illustrates a system 100 for reducing corrosion and fouling that includes a mixing unit 102, a generator 103, and a chemical dosing unit 104. FIG. 1 is a schematic side view of the system 100. The mixing unit 102 has a generally ball-like shape with blades 105 mounted on a body 106 with a shaft 107. The mixing unit 102 is installed in a pipeline 110 with the blades 105 inside the pipeline 110. When fluid is flowing through the pipeline 110 as indicated by arrows 111, the fluid and the blades 105 of the mixing unit 102 interact with the fluid with the interaction rotating the blades 105 around an axis aligned with the shaft 107 and mixing the fluid flowing past the blades 105. The blades 105 and the shaft 107 are fixed in position relative to each other so that rotation of the blades 105 rotates the shaft 107. The blades 105 of the mixing unit 102 are helical blades defining a generally hollow inner space around which the blades 105 rotate. Although illustrated with helical blades 105, some systems have other blade configurations.

The shaft 107 is coupled to the generator 103 and rotation of the shaft 107 drives the generator 103 to produce electricity. In the system 100, the generator 103 is electrically coupled to and provides power to the chemical dosing unit 104. When the systems 100 are installed near an electrical power grid, the generator 103 may be coupled to and feed power to the electrical power grid. In other locations, the systems 100 can be installed with the generator 103 electrically coupled to and powering local systems which are not connected to another electrical power grid. Examples of such local systems include pumps, sensors, control systems, and valves. U.S. Pat. No. 8,360,720, the entire contents of which are incorporated herein by reference, provides details of some possible generators. In some systems, the mixing unit 102 is installed without an associated generator.

The chemical dosing unit 104 includes sensors, pumps, and a control system. The control system receives signals from the sensors with the signals providing data about characteristics (e.g., pH, temperature, pressure, and/or dissolved salt concentrations) of the fluid flowing through the pipeline 110. Based on this data, the control system can send signals actuating the pumps to inject corrosion and/or fouling inhibitors into the pipeline 110. The chemical dosing unit 104 is an optional feature of the system 100. In some locations, mixing provided by the mixing unit 102 avoids the need for chemical inhibitors altogether. In some locations, the inhibitory effects of the mixing unit 102 need to be supplemented by the addition of chemical inhibitors to fluid in the pipeline 110. In these locations, the chemical dosing unit 104 is typically installed upstream of the mixing unit 102. This configuration provides a more homogenous distribution of the chemical inhibitors downstream of the mixing unit 102.

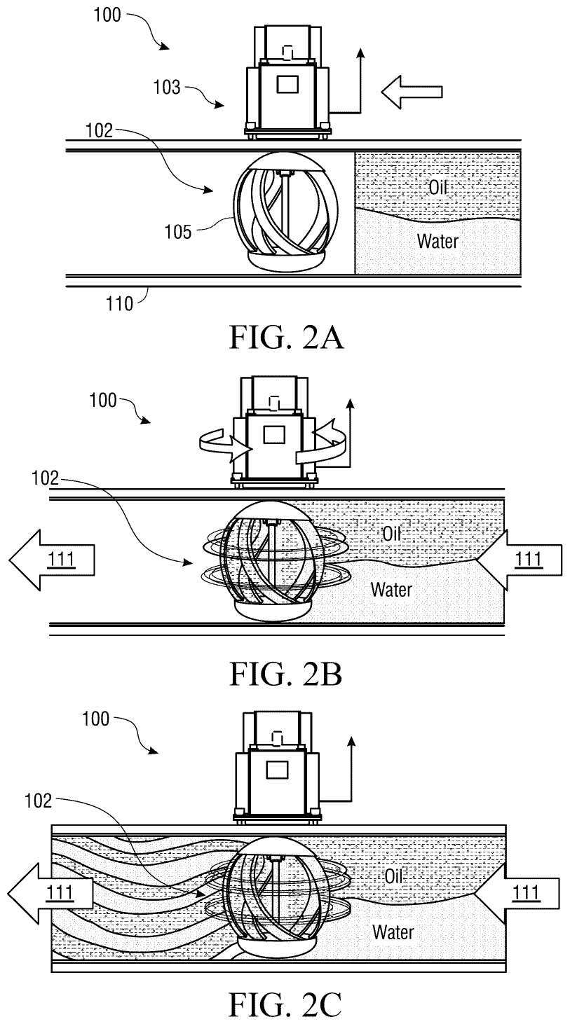

FIGS. 2A-2C are schematic side views illustrating application of the system 100 to a section of pipeline 110 in which oil and water have separated. For example, this situation could occur where pipelines carry multiphase flow (e.g., oil, gas, and water) from oil wells. In this implementation, the system 100 does not include a chemical dosing unit and electricity produced by the generator 103 is fed to a facility electrical grid.

In FIG. 2A, still fluid in the pipeline has separated with the oil floating on the water. As the flow is restarted, the separated oil and water move towards the system 100 and begin to rotate the blades 105 of the mixing unit 102 as shown in FIG. 2B. As the blades 105 begin to rotate, the generator 103 begins to produce electricity. As the oil and water flow past the system 100, the blades 105 mix the oil and water together as shown in FIG. 2C.

For example, oil wells typically produce a hot mixture of crude oil, water, carbon dioxide, sulfur, and microorganisms. When the amount of water in the oil is low and/or the fluids in the pipeline are flowing quickly, the water will be dispersed in tiny droplets suspended in the flow that is unlikely to react with steel pipe surfaces. However, in stretches of pipeline at lower pressures, water droplets can coalesce out of the oil flow. When this occurs, the water and associated contaminants provide a favorable environment for corrosion. In addition, brine or carbon dioxide added to a reservoir during enhanced oil recovery can be produced, inadvertently adding to the risk of corrosion.

Specific locations for installation of the system 100 are typically determined based on feedback from corrosion, biological, and process engineers who predict the most likely point of corrosion and fouling accumulation. Typically, the system is installed in low velocity flow portion of a pipe, where stagnancy of the bottom layer of the flow can occur.

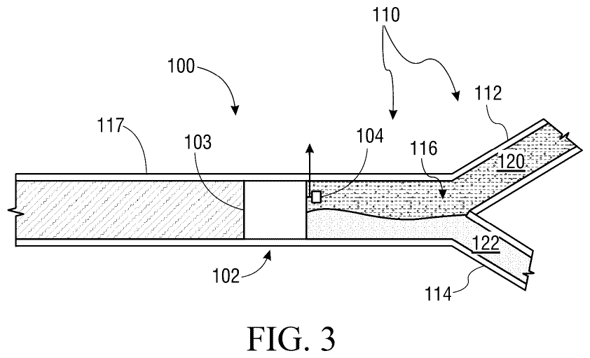

FIG. 3 is a schematic top view of illustrating an application of the system in which the pipeline 110 includes two feeder pipes 112, 114 that meet at a junction 116 discharging to a larger pipe 117. Foulants include scale deposits and microorganisms (biofouling). Scaling often occurs when two or more streams are mixed inside a pipeline. Based on the nature of the streams, some compounds reach saturation and turn into deposits that adhere to the inside surfaces of the pipeline. Biofouling occurs in a similar way to scaling, with the main difference is that its microbial organisms (bacteria, fungi, archaea) that travel with the stream and adhere to surfaces inside pipelines through biofilm formation. This biofilm, unlike scale accumulation, grows unpredictably inside the pipeline.

Fluid in the feeder pipe 112 and fluid in the feeder pipe 114 have different characteristics (e.g., pH, temperature, pressure, and/or dissolved salt concentrations). For example, the fluid in the feeder pipe 112 can be a first fluid from a first wellhead or formation and the fluid in the feeder pipe 114 can be a second fluid from a second wellhead or formation. Although only two feeder pipes are shown for clarity of illustration, more than two feeder pipes from more than two formations may be merged at a single junction or in a series of junctions.

The fluid in the feeder pipe 112 and the fluid in the feeder pipe 114 are joined at the junction 116 to form a combined flow 118. The combined flow 118 is initially incompletely mixed which can produce conditions that promote corrosion (e.g., conversion of refined metals into their oxides) or fouling (e.g., the accumulation and depositing of unwanted chemicals outside or inside tanks, pipelines, and other equipment in the production and processing of oil, gas, and other energy products derived from oil and gas).

For example, the combined flow 118 may have conditions (e.g., pH, temperature, and pressure) for which salts dissolved in the tributary flows 120, 122 are present at concentrations above saturation for the conditions in the combined flow 118. Particular scales and biofoulants, such as calcium-sulfate (CaSO₄), calcium carbonate (CaCO₃), and bacteria found in produced water, tend to accumulate in pipelines in which two or more streams from different formations are suddenly merged during the oil production from different wellheads. At this point, the two streams usually have different properties (temperature, pH, salinity, etc.). This provides favorable conditions for scale and biofouling formation in which compounds are suddenly mixed and left to saturate, creating the fouling deposits.

To reduce the likelihood that incomplete mixing of the combined flow 118 produces conditions that promote corrosion or fouling, the mixing unit 124 is installed downstream of the junction 116. As shown in FIG. 3, the mixing unit 102 increases homogeneity of the combined flow 118 in the pipeline 110. Specific locations for installation of the system 100 are typically determined based on feedback from corrosion, biological, and process engineers who predict the most likely point of corrosion and fouling accumulation.

For example, determining that incomplete mixing of the fluid produced from the first formation and the fluid produced from the second formation produces conditions that promote corrosion or fouling can include identifying a location downstream of the junction where pH, pressure, temperature, and components of the combined flow lead to separation and accumulation of a water phase in the pipeline. In some cases, separation and accumulation of a water phase occurs along a bottom surface of the pipeline and can lead to a corrosion-formed channel in the bottom surface of the pipeline. In some cases, separation and accumulation of a water phase occurs along a top surface of the pipeline due to condensation.

In another example, determining that incomplete mixing of the fluid produced from the first formation and the fluid produced from the second formation produces conditions that promote corrosion or fouling includes identifying a location downstream of the junction where pH, pressure, temperature, and components of the combined flow allow salts dissolved in the mixed fluids to exceed saturation limits. For example, calcium-sulfate (CaSO₄) and calcium carbonate (CaCO₃) have the potential to cause fouling.

It is anticipated that systems 100 will typically be installed between 50 and 500 (depending on the size of the pipe and the flow rate/velocity) meters downstream of the associated junction. After the location(s) are selected, the system(s) 100 are installed inside pipelines during periods of shutdowns.

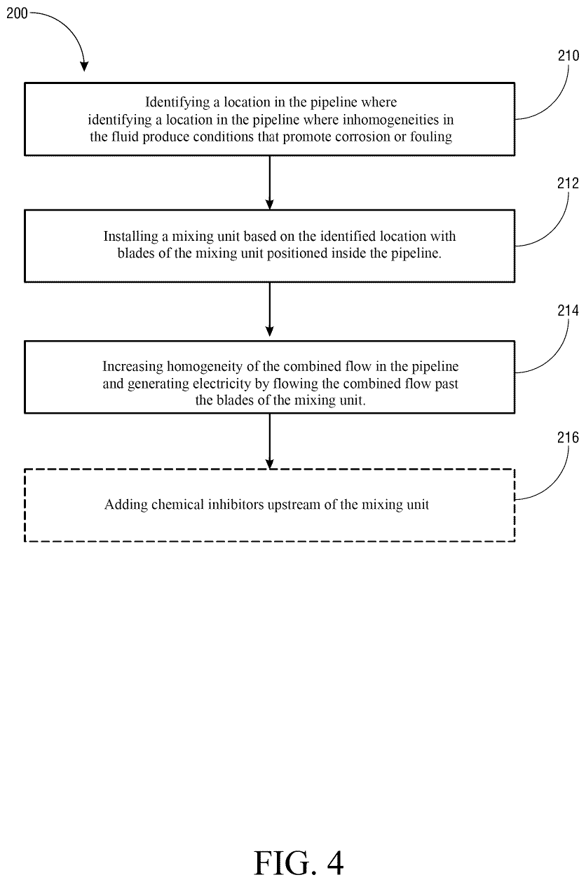

FIG. 4 is a flowchart of a method 200 of reducing corrosion and fouling inside pipelines. In describing the method 200, reference numbers used with respect to FIG. 1 are used to indicate example physical components associated with the method 200.

The method 200 for reducing corrosion or fouling in a pipeline can be used for reducing corrosion or fouling in a pipeline. A location in the pipeline where inhomogeneities in the fluid produce conditions that promote corrosion or fouling is identified (step 210). For example, identifying the location in the pipeline where inhomogeneities in the fluid produce the conditions that promote corrosion or fouling an be based on identifying a location where pressure, temperature, and flow velocity cause separation and accumulation of a water phase in the pipeline (e.g., separation and accumulation of a water phase occurs along a bottom surface of the pipeline and/or separation and accumulation of a water phase occurs along a top surface of the pipeline due to condensation). Alternatively of additionally, the fluid can be from different formations or different wellheads.

In some cases, it is determined that incomplete mixing of the fluid produced from the first formation and the fluid produced from the second formation produces conditions that promote corrosion or fouling. Optionally, a location in the pipeline 110 where the incomplete mixing of the fluid produced from the first formation and the fluid produced from the second formation produces the conditions that promote corrosion or fouling is identified before a mixing unit 102 is installed. In some cases, the mixing unit 102 is installed is between 50 and 500 meters downstream of the junction 116. Determining that incomplete mixing of the fluid produced from the first formation and the fluid produced from the second formation produces conditions that promote corrosion or fouling can include identifying a location downstream of the junction 116 where pH, pressure, temperature, and components of the combined flow 118 lead to separation and accumulation of a water phase in the pipeline 110 (e.g., separation and accumulation of a water phase occurs along a bottom surface of the pipeline 110 and/or along a top surface of the pipeline 110 due to condensation). Additionally or alternatively, determining that incomplete mixing of the fluid produced from the first formation and the fluid produced from the second formation produces conditions that promote corrosion or fouling can include identifying a location downstream of the junction 116 where pH, pressure, temperature, and components of the combined flow 118 allow salts dissolved in the mixed fluids to exceed saturation limits.

Once an appropriate location is identified, a mixing unit 102 is installed downstream of the junction 116 with blades 105 of the mixing unit 102 positioned inside the pipeline 110 (step 212). In some cases, the blades 105 of the mixing unit 102 are coupled to a shaft of a generator 103.

Homogeneity of the combined flow 118 in the pipeline 110 is increased by flowing the combined flow 118 past the blades 105 of the mixing unit 102 (step 214). Generally, flowing the combined flow 118 past the blades 105 of the mixing unit 102 also generates electricity. During normal operations, the flow of the hydrocarbon streams rotate the blades 105 at high speeds and create a vigorous mixing area inside the pipeline 110. This area will mix the various merged streams coming from upstream and can disrupt scale and biofouling accumulation by unifying the flow and temperature of the merged stream.

The method 200 optionally can also include adding chemical inhibitors upstream of the mixing unit 102 (step 216). In some cases, the chemical inhibitors are added between the junction 116 and the mixing unit 102. The addition may be performed using chemical dosing station powered by electricity produced by the generator 103.

### EXAMPLES

In some implementations, methods for reducing corrosion or fouling in a pipeline transporting fluid produced from a first formation include: identifying a location in the pipeline where inhomogeneities in the fluid produce conditions that promote corrosion or fouling; installing a mixing unit based on the identified location with blades of the mixing unit positioned inside the pipeline and coupled to a shaft of a generator of the mixing unit; and increasing homogeneity of the flow in the pipeline and generating electricity by flowing the combined flow past the blades of the mixing unit.

In some implementations, methods for reducing corrosion or fouling in a pipeline include: identifying a location in the pipeline where inhomogeneities in the fluid produce the conditions that promote corrosion or fouling; installing a mixing unit based on the identified location with blades of the mixing unit positioned inside the pipeline; and increasing homogeneity of fluid in the pipeline downstream of the mixing unit by flowing the combined first fluid and second fluid past the blades of the mixing unit.

In an example implementation combinable with any other example implementation, identifying the location in the pipeline where inhomogeneities in the fluid produce the conditions that promote corrosion or fouling includes identifying a location where pressure, temperature, and flow velocity cause separation and accumulation of a water phase in the pipeline. In some cases, separation and accumulation of a water phase occurs along a bottom surface of the pipeline. In some cases, separation and accumulation of a water phase occurs along a top surface of the pipeline due to condensation.

In an example implementation combinable with any other example implementation, methods also include combining the fluid produced from the first formation with fluid produced from a second formation at a junction in the pipeline to form a combined flow. In some cases, methods also include identifying a location in the pipeline where the incomplete mixing of the fluid produced from the first formation and the fluid produced from the second formation produces the conditions that promote corrosion or fouling. In some cases, the fluid produced from the first formation and the fluid produced from the second formation have different temperatures, pHs, and/or salinities. In some cases, the location in the pipeline is between 50 and 500 meters downstream of the junction. In some cases, identifying the location in the pipeline where the incomplete mixing produces the conditions that promote corrosion or fouling includes identifying a location downstream of the junction where pH, pressure, temperature, and components of the combined flow cause salts dissolved in the mixed fluids to exceed saturation limits.

In an example implementation combinable with any other example implementation, methods also include adding chemical inhibitors upstream of the mixing unit. In some cases, adding chemical inhibitors upstream of the mixing unit includes adding chemical inhibitors between the junction and the mixing unit. In some cases, adding chemical inhibitors upstream of the mixing unit includes using chemical dosing station powered by electricity produced by the generator.

In an example implementation combinable with any other example implementation, the blades are helical blades.

A number of embodiments of the systems and methods have been described. Nevertheless, it will be understood that various modifications may be made without departing from the spirit and scope of this specification. Accordingly, other embodiments are within the scope of the following claims.

What is claimed is:

1. A method for reducing corrosion or fouling in a pipeline transporting fluid produced from a first formation, the method comprising:
identifying a location in the pipeline where inhomogeneities in the fluid produce conditions that promote corrosion or fouling;
installing a mixing unit based on the identified location with blades of the mixing unit positioned inside the pipeline and coupled to a shaft of a generator of the mixing unit; and
increasing homogeneity of the flow in the pipeline and generating electricity by flowing the combined flow past the blades of the mixing unit.

2. The method of claim 1, wherein identifying the location in the pipeline where inhomogeneities in the fluid produce the conditions that promote corrosion or fouling comprises identifying a location where pressure, temperature, and flow velocity cause separation and accumulation of a water phase in the pipeline.

3. The method of claim 2, wherein separation and accumulation of a water phase occurs along a bottom surface of the pipeline.

4. The method of claim 3, wherein separation and accumulation of a water phase occurs along a top surface of the pipeline due to condensation.

5. The method of claim 1, further comprising combining the fluid produced from the first formation with fluid produced from a second formation at a junction in the pipeline to form a combined flow.

6. The method of claim 5, further comprising identifying a location in the pipeline where the incomplete mixing of the fluid produced from the first formation and the fluid produced from the second formation produces the conditions that promote corrosion or fouling.

7. The method of claim 6, the fluid produced from the first formation and the fluid produced from the second formation have different temperatures, pHs, and/or salinities.

8. The method of claim 6, wherein the location in the pipeline is between 50 and 500 meters downstream of the junction

9. The method of claim 6, wherein identifying the location in the pipeline where the incomplete mixing produces the conditions that promote corrosion or fouling comprises identifying a location downstream of the junction where pH, pressure, temperature, and components of the combined flow cause salts dissolved in the mixed fluids to exceed saturation limits.

10. The method of claim 1, further comprising adding chemical inhibitors upstream of the mixing unit.

11. The method of claim 10, wherein adding chemical inhibitors upstream of the mixing unit comprises adding chemical inhibitors between the junction and the mixing unit.

12. The method of claim 10, wherein adding chemical inhibitors upstream of the mixing unit comprising using chemical dosing station powered by electricity produced by the generator.

13. The method of claim 1, wherein the blades are helical blades.

14. A method for reducing corrosion or fouling in a pipeline, the method comprising:
identifying a location in the pipeline where inhomogeneities in the fluid produce the conditions that promote corrosion or fouling;
installing a mixing unit based on the identified location with blades of the mixing unit positioned inside the pipeline; and
increasing homogeneity of fluid in the pipeline downstream of the mixing unit by flowing the combined first fluid and second fluid past the blades of the mixing unit.

15. The method of claim 14, wherein identifying the location in the pipeline where inhomogeneities in the fluid produce the conditions that promote corrosion or fouling comprises identifying a location where pressure, temperature, and flow velocity cause separation and accumulation of a water phase in the pipeline.

16. The method of claim 15, wherein separation and accumulation of a water phase occurs along a bottom surface of the pipeline.

17. The method of claim 14, further comprising adding chemical inhibitors upstream of the mixing unit.

18. The method of claim 17, wherein adding chemical inhibitors upstream of the mixing unit comprises adding chemical inhibitors between the junction and the mixing unit.

19. The method of claim 18, wherein adding chemical inhibitors upstream of the mixing unit comprising using chemical dosing station powered by electricity produced by the generator.

20. The method of claim 14, wherein the blades are helical blades.
